(19) United States
(12) Patent Application Publication
(10) Pub. No.: US 2025/0209796 A1
(43) Pub. Date: Jun. 26, 2025

(54) GENERATING ANNOTATED DATA SAMPLES FOR TRAINING USING TRAINED GENERATIVE MODEL

(71) Applicant: International Business Machines Corporation, Armonk, NY (US)

(72) Inventors: Markus POBITZER, Zurich (CH); Filip Michal JANICKI, Zurich (CH); Mattia RIGOTTI, Basel (CH); Adelmo Cristiano Innocenza MALOSSI, Schönenberg (CH)

(21) Appl. No.: 18/394,509

(22) Filed: Dec. 22, 2023

(51) Int. Cl. G06V 10/774; G06T 5/20; G06T 5/77; G06V 10/26; G06V 10/82

(52) U.S. Cl. CPC G06V 10/774; G06T 5/20; G06T 5/77; G06V 10/26; G06V 10/82; G06T 2207/20081; G06T 2207/20084

(57) ABSTRACT

An example system includes a processor to receive an annotated data sample comprising an object contained in an annotated mask. The processor can partially erase the object contained in the annotated mask. The processor can fill out an erased area of the object a predetermined number of times via a generative model to generate additional annotated data samples.

### BACKGROUND

The present techniques relate to training segmentation learning models. More specifically, the techniques relate to automatically generating annotated data samples to be used for training segmentation learning models.

### SUMMARY

According to an embodiment described herein, a system can include processor to receive an annotated data sample including an object contained in an annotated mask. The processor can also further partially erase the object contained in the annotated mask. The processor can also fill out an erased area of the object a predetermined number of times via a trained generative model to generate an additional annotated data sample.

According to another embodiment described herein, a method can include receiving, via a processor, an annotated data sample including an object contained in an annotated mask. The method can further include partially erasing, via the processor, the object contained in the annotated mask. The method can also further include filling out, via the processor, an erased area of the object via a trained generative model to generate an additional annotated data sample.

According to another embodiment described herein, a computer program product for generating can include computer-readable storage medium having program code embodied therewith. The program code executable by a processor to cause the processor to receive an annotated data sample including an object contained in an annotated mask. The program code can also cause the processor to partially erase the object contained in the annotated mask. The program code can also cause the processor to fill out an erased area of the object a predetermined number of times via a generative model to generate additional annotated data samples.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a segmented image training generator;

FIG. 2 is an example tangible, non-transitory computer-readable medium that can generate segmented training images;

FIG. 3 is a process flow diagram of an example method that can train a segmentation learning model using generated annotated data samples;

FIG. 4 is a block diagram of an example system for training segmentation machine learning models with automatically augmented training datasets; and

FIG. 5 is a set of images demonstrating an example generation of training images based on an example single segmented image of a bus.

### DETAILED DESCRIPTION

Semantic Instance Segmentation is the task of detecting objects in an image and creating a pixel-wise mask for each detected object. Computer vision algorithms based on machine learning have drastically increased the accuracy of semantic instance segmentation. However, computer vision algorithms may use large training datasets. In particular, the size and variation of instance segmentation datasets may affect the accuracy and robustness of computer vision models trained thereon. However, such datasets may be costly to produce because the process of providing pixel-wise annotations for all objects in a given image may be demanding with respect to both time and labor. As one example, manually generating course annotations of images of cracks in concrete walls may take a time of six seconds per defect and 10 minutes per image, while more fine annotations may take up to one minute per defect and an hour and 40 minutes per image. Thus, obtaining accurate mask annotations to produce high-quality segmentation datasets may be a costly and labor-intensive process.

Diffusion probabilistic models, also referred to as diffusion models (DMs), are used to generate realistic textures and images based on input textual descriptions. DMs were first introduced for the generation of realistic textures and images. Denoising Diffusion has two parts: a forward diffusion process and a reverse process. In the forward diffusion process, given a sample x₀ from a distribution q, Gaussian noise may be progressively added with increasing variance βₜ to define a forward diffusion process. Doing this T times leads to x₁, . . . , x_{T} noisy samples. Letting T→∞ will let the distribution of x_{T} approach the isotropic Gaussian distribution. In practice, T may be chosen large enough that x_{T} is close to being isotropically distributed and close to Gaussian. As one example, this progression may be defined using the equation:

$$q ( {x}_{t} \vert {x}_{t - 1} ) = N ( {x}_{t} ; \sqrt{1 - {β}_{t}} {x}_{t - 1} , {β}_{t} I ) \qquad Eq . 1$$

where {βₜ ∈(0, 1)}ₜ₋₁^{T} is a deterministic set of variance parameter. The probability distribution of xₜ can be computed directly from the input x₀ as:

$$q ( {x}_{t} \vert {x}_{0} ) = N ( {x}_{t} ; \sqrt{{\overline{α}}_{t}} {x}_{0} , ( 1 - {\overline{α}}_{t} ) I ) \qquad Eq . 2$$

where αₜ=1−βₜ and α̅ₜ=Πᵢ₌₁^{t} αᵢ. The reverse diffusion process may then start with isotropic Gaussian noise x_{T}˜N(0, I) and progressively remove the added noise from a noisy sample. As the reverse probability distribution q (xₜ₋₁|xₜ) is not readily available we estimate its approximation as:

$${p}_{θ} ( {x}_{t - 1} \vert {x}_{t} ) = N ( {x}_{t - 1} ; {μ}_{θ} ( {x}_{t} , t ) , {\sum }_{θ} ( {x}_{t} , t ) ) \qquad Eq . 3$$

where μ_{θ} and Σ_{θ} are approximated by neural networks. These are then trained so as to lead to the generation of random samples following the original data distribution q(x₀). Some methods introduced slight changes in the reverse process, drastically reducing the number of time steps of the reverse process T needed to obtain good quality final samples. With respect to the learning object, when training the parameters of the model p_{θ}, a variational lower bound may be used on the negative log likelihood. Training of μ_{θ} will then proceed by estimating a noise factor ϵ_{θ} that gets added to the current image, while Σ_{θ} can be assumed fixed to unity. Some methods hold that predicting ϵ worked best and train the network with a simplified loss term:

$${ℒ}_{simple} = {𝔼}_{t , {x}_{0} , ϵ} [ {‖ ϵ - {ϵ}_{θ} ( {x}_{t} , t ) ‖}^{2} ] \qquad Eq . 4$$

Other methods improve upon these results by also learning the variance Σ_{θ}(xₜ, t).

Latent diffusion models are a specific type of DM that has reduced the computational requirements for the generation of high-resolution images by applying the diffusion process in a lower dimensional latent space and training an encoder and decoder that can map from an image to the latent space. Stable Diffusion (SD) is an example of a latent diffusion model that is specifically trained on Laion-5B, a dataset containing image-text pairs. With SD models, the content of images can be guided through text with the help of classifier free-guidance.

Inpainting is the task of filling out parts of an image specified by a mask. Some methods use convolution techniques to perform inpainting. In particular, some methods may use a global and a local understanding of a scene in order to inpaint more challenging portions of an image. Some methods also use DMs by altering the reverse diffusion process to achieve realistic results even when using extreme masks. However, such methods may not have been developed to work with the latent space as in SD. Moreover, applying such methods to the latent space of SD may result in inaccurate mask-object correspondence due to the loss of pixel level control. To partially solve these problems, it is possible to train SD specifically for inpainting.

According to embodiments of the present disclosure, a system includes a processor that can receive an annotated data sample including an object contained in an annotated mask. The processor can partially erase the object contained in the annotated mask. The processor can fill out an erased area of the object a predetermined number of times via a trained generative model to generate additional annotated data samples. For example, the trained generative model may be a diffusion-based inpainting model, such as an inpainting model trained on a latent diffusion model. In particular, the techniques described herein relate to a system and method for generating new images using a generative model to fill out the masked area with a desired object class by guiding the diffusion through the object outline. An example method generates new annotated data samples starting from pre-existing annotated data samples by making use of a morphological erosion process to partially erase the annotated mask in order to make the diffusion-based inpainting model use this erased boundary of the object as a guidance to fill out the area within the shrunk mask with a desired object class. This method relies on the technical observation that the outline of the erased object provides a robust guiding mechanism that the diffusion model can leverage to construct a realistic new variation of the partially erased object. The object outline thus provides a simple, but also reliable and convenient training-free guidance signal for the underlying inpainting model that is often sufficient to fill out the mask with an object of the correct class without further text guidance and preserve the correspondence between generated images and the mask annotations with high precision. The techniques also include a method to enlarge a given dataset for instance segmentation to obtain a larger dataset that can be used to train an improved instance of a segmentation machine learning model. For example, the dataset may be made up of images paired with mask annotations of the object contained in the images. Thus, embodiments of the present disclosure enable automated generation of annotated data samples, such as segmented training images, that can be used to augment training datasets for more robust training computer vision models. In this manner, a small annotated instance segmentation dataset can be augmented to effectively obtain a sizeable annotated dataset. Moreover, the techniques can be used to generate the additional segmented training images without additional training involved for the generation. Thus, any suitable available pretrained diffusion models can be used without any additional training or fine-tuning. In addition, the techniques maintain the object boundary and consistency with the original mask annotation. Finally, the techniques are also combinable with other image augmentations to provide even more variety of training samples. For example, additional image augmentations may include geometric transformations, such as rotation and flipping of the training images, pixel-level transformations, such as a change in color and blurring of the training images, among other types of augmentations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a segmented training image generator 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

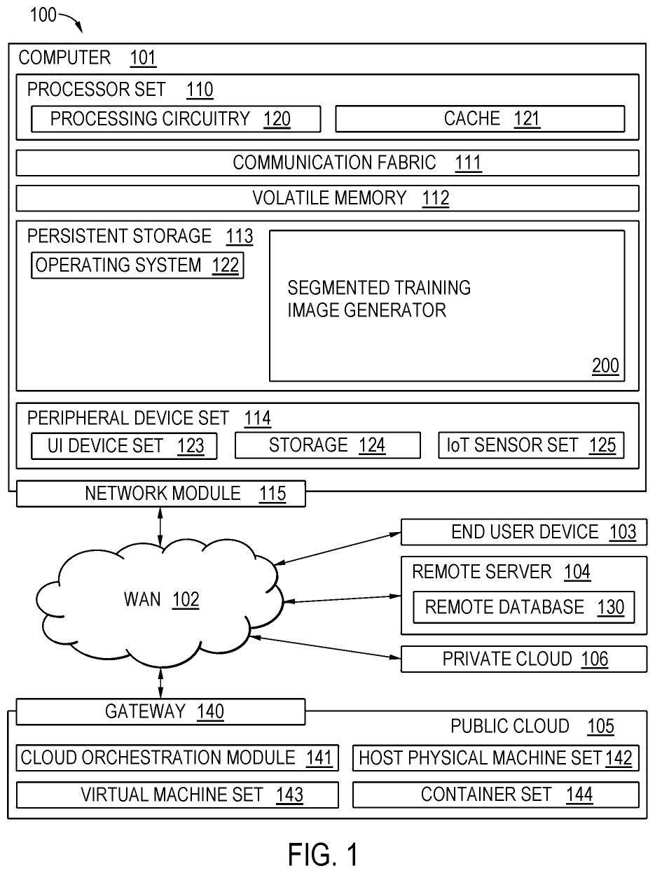

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

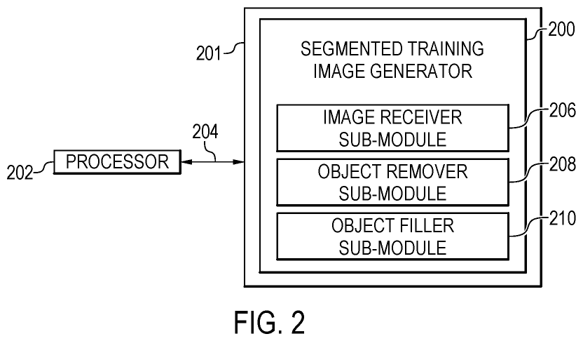

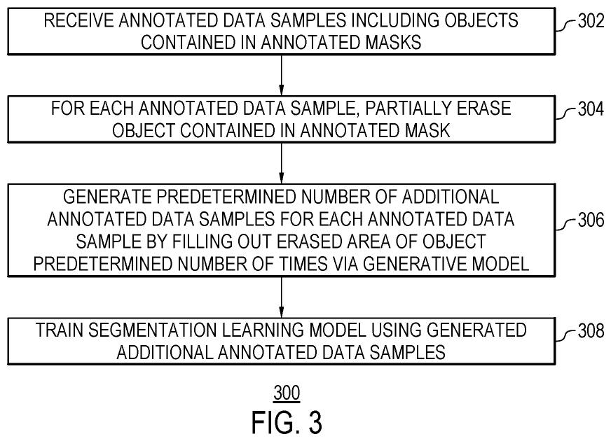

Referring now to FIG. 2, a block diagram is depicted of an example tangible, non-transitory computer-readable medium 201 that can generate segmented training images. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the method 300 of FIG. 3.

The various software components discussed herein may be stored on the tangible, non-transitory, computer-readable medium 201, as indicated in FIG. 2. For example, an image receiver sub-module 206 includes code to receive an annotated data sample including an object contained in an annotated mask. An object remover sub-module 208 includes code to partially erase the object contained in the annotated mask. The object remover sub-module 208 further includes code to erode the annotated mask to generate an eroded mask and erase an area of the object within the eroded mask. The object remover sub-module 208 also includes code to receive an erosion kernel and erode the annotated mask based on the erosion kernel. For example, the erosion kernel may be set to any suitable size, such as 12×12 pixels for some objects. An object filler sub-module 210 includes code to fill out an erased area of the object a predetermined number of times via a generative model to generate an additional annotated data sample. For example, the generative model may be a diffusion-based inpainting model. The object filler sub-module 210 also includes code to receive a text prompt and fill out the erased area using the generative model guided by the text prompt. In various example, the object filler sub-module 210 also includes code to fill the erased area of the object via the diffusion-based inpainting model a predetermined number of times to generate a number of additional annotated data samples having the same annotation as the annotated data sample.

It is to be understood that any number of additional software components not shown in FIG. 2 may be included within the tangible, non-transitory, computer-readable medium 201, depending on the specific application. For example, a model trainer may additionally be included that is configured to train a segmentation learning model using the generated additional annotated data samples.

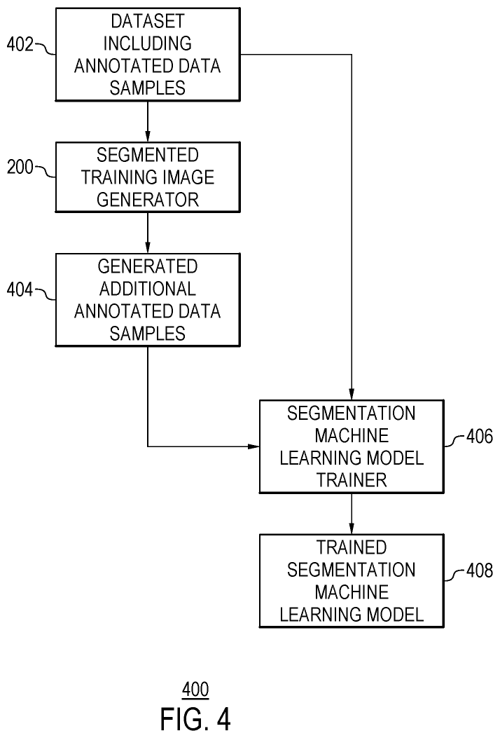

FIG. 3 is a process flow diagram of an example method that can train a segmentation learning model using generated annotated data samples. The method 300 can be implemented with any suitable computing device, such as the computer 101 of FIG. 1. For example, the methods described below can be implemented by the processor set 110 of FIG. 1 or in system 400 of FIG. 4.

At block 302, an annotated data sample that includes an object contained in an annotated mask is received. For example, the annotated mask may indicate an associated class of the masked object. In some examples, the annotated data samples may include multiple objects with multiple annotated masks.

At block 304, for each annotated data sample, the object contained in the annotated mask is partially erased. In some examples, any number of annotated objects within the data sample may be similarly partially erased. For example, the annotated mask can be eroded to generate an eroded mask and erase an area of the object within the eroded mask to partially erase the object. In some embodiments, the objects may be partially erased using an erosion kernel that specifies a size of an outer portion of the mask to be eroded. The eroded mask can then be used to partially erase the corresponding object.

At block 306, generate additional annotated data samples by filling out an erased area of the object a predetermined number of times via a generative model. For example, the generative model may be a diffusion-based inpainting model. In various examples, the diffusion-based inpainting model may be an inpainting model trained on top of a latent diffusion model. In various examples, any other suitable generative models, such as generative adversarial networks (GANs), transformer based models, auto-encoder based models, among other generative models trained using images. In various examples, the generated additional annotated data samples are image-mask pairs that include the annotated mask of the annotated data sample. In some examples, the associated class from the annotated mask can also be input as a text guidance into the diffusion-based inpainting model. In various examples, additional text guidance can be received and used to guide the diffusion-based inpainting model. For example, the text guidance can be positive text guidance or negative text guidance. In various examples, an edge of the filled out area of the object is blended with an original outer portion of the object that was not erased. For example, the edge of the filled out area can be blended with the edge of the original portion of the object using a Gaussian filter.

At block 308, a segmentation learning model is trained using the generated additional annotated data samples. For example, the segmentation learning model may be trained using the generated additional annotated data samples to segment images into objects and backgrounds. In various examples, training the segmentation learning model may include various neural network training techniques, such as the use of gradient descent, any suitable loss function. As one specific example, in engineering applications, the segmentation learning model may be trained to detect defects in concrete walls. Such a segmentation learning model may detect both the location and a size of the defects.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

With reference now to FIG. 4, a block diagram shows an example system for training segmentation machine learning models with automatically augmented training datasets. The example system 400 of FIG. 4 includes the segmented training image generator 200 shown receiving a dataset 402 including annotated data samples. The system includes generated additional annotated data samples 404, shown being generated by the segmented training image generator 200. The system 400 includes a segmentation machine learning model trainer 406 communicatively coupled to the segmented training image generator 200. The segmentation machine learning model trainer 406 is shown generating a trained segmentation machine learning model 408. For example, the trained segmentation machine learning model 408 may be a neural network, such as a U-Net (version 1 first released in May 2015), SegFormer (version 1 first released in May 2021), Mask R-CNN (version 1 first released in March 2017), or Swin Transformer (version 1 first released in March 2021), among other suitable networks. In some examples, the segmentation machine learning model trainer 406 also includes code to fine-tune the output of the trained segmentation machine learning model 408 for a certain task. For example, the trained segmentation machine learning model 408 may be trained on general training data and then fine-tuned using training data that is more specific to the certain task.

In the example of FIG. 4, the system 400 can use mask annotations to partially remove objects by morphological erosion of the masks and applying the eroded masks to the bulk of the objects that are annotated in an image, thus leaving their outline intact. The system 400 can then use the inpainting model to fill out the object, relying on its capacity to latch onto the remaining outline to guide the generation. This simultaneously achieves that the newly generated image is consistent with the overall context in the scene, and that the inpainted object remains still within the mask annotation of the original image. The original mask annotation can therefore serve as a high-quality ground truth annotation of the newly generated images. The outline of an object is thus a very strong guidance since the outline contains the size and often also indicates the orientation of the object. Additionally, the outline of the object can also provide other features such as color, shape, and texture. Therefore, the outline alone can be a strong guidance for the inpainting method used by the segmented training image generator 200. Not only does the outline allow the segmented training image generator 200 to continue the seen texture, but the outline also provides a means to infer the object class.

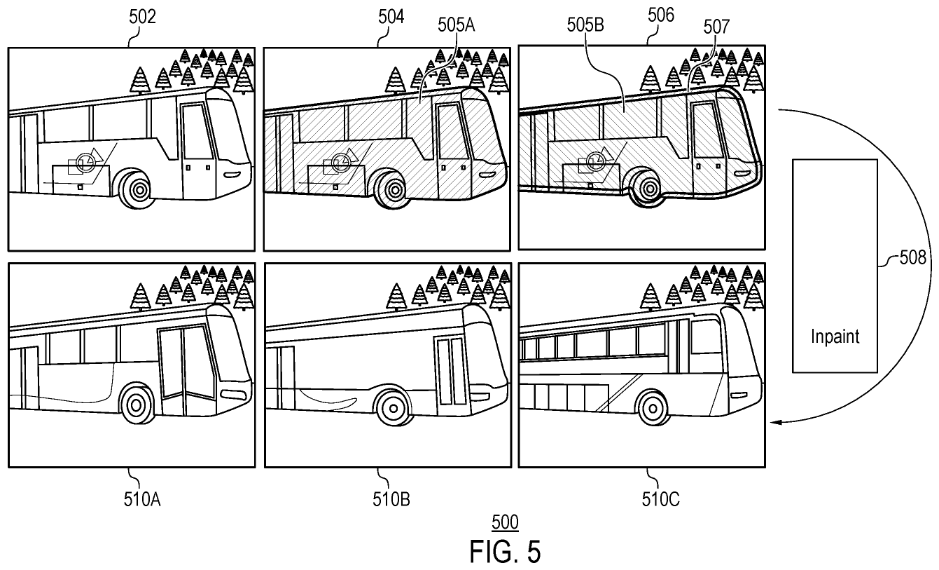

However, in some cases, the object outline may not be informative enough to infer the object class. For example, an outline only inpainting method may fail in cases where the shape is too generic, or does not align well with the object class. In such cases, the addition of text guidance can be used to steer the generation in the right direction. Thus, in various embodiments, the system 400 can guide the inpainting model through text with the information of the object class, among other input text guidance. As one example, the way that a particular used inpainting model was trained may have placed high importance on the scene around the mask. In this example, adding a text prompt that contains the class information of the object can enable the inpaintings produce image features that align well with real life objects. An example procedure that can be performed using system 400 is presented in FIG. 5.

In addition, the object outline can also limit the diversity of the produces image variations. This effect may strongly depend on the size of the erosion kernel, as it trades off prior information about the object and freedom in the generation. In various examples, the techniques described herein can therefore be combined with additional prepossessing steps to the original image to create more diverse outputs. For example, such additional preprocessing steps may include geometric transformations, such as rotation, and scaling and pixel-wise transformations, such as a changing the color in the object outline.

In some examples, the system 400 may fail completely fill the erased portion by the object, such as when the mask fills a large part of the image or the object is placed in an unnatural environment. In such cases, the erosion size can be increased to guide the inpainting model towards better compliance of the boundaries of the mask. In addition, the use of negative text prompts may also help overcome such issues.

In some examples, the system 400 may not perform well for certain objects that may have not been included in the original training of the generative model. In these examples, the generative model may then be fine-tuned on the unseen object. However, this may be resource intensive because all the weights may be trained using the fine-tuning. Therefore, in some examples, a Low-rank Adaptation of Large Language Models (LoRA) method may be used, in which small trainable parameters are injected into a language model. Similarly, small trainable parameters may be injected into the generative model in order to fine-tune the generative model for unseen objects. In addition, in some embodiments, a custom diffusion may be used. For example, cross attention layers may be fine-tuned instead of the whole generative model. In this manner, fine-tuning the generative model for specific classes of objects may be more efficient.

As one example, a chosen text prompt may be “Photo of a C*” or “Photo of several C*” for inpainting more than one instance, where “C*” is the class of the object. In various embodiments, any other suitable text prompt may be used. In this example, the word “Photo” may be used instead of the alternatives of “Image”, “Picture”, and “Photograph” because “Photo” is associated with a real scene. Moreover, the word “Photograph” is often linked with a depiction of a picture frame too, which may not be desirable. In some examples, “Image of C” or just “C*” may be alternatively used as a prompt. In some examples varying the text description led to more variations in the produced image features, for the text prompt “Photo of a dog”, where dog is the class of the object, “Photo of a Labrador Retriever dog” can be written instead. In various embodiments, negative prompts may also be used to guide the inpainting model. For example, experiments were conducted with the use of a negative prompt, namely: “disfigured, kitsch, ugly, oversaturated, grain, low-res, deformed, blurry, bad anatomy, disfigured, poorly drawn face, mutation, mutated, extra limb, ugly, poorly drawn hands, missing limb, blurry, floating limbs, disconnected limbs, malformed hands, long neck, long body, ugly, disgusting, poorly drawn, childish, mutilated, mangled, surreal”. In various embodiments, any other suitable negative prompts may be used depending on the class of the object. The text prompts may help better specify which features of a certain class should be inpainted. For example, it may be ambiguous to create the desired object just by its outline and therefore the text prompt can be used to provide more specific control.

As another example, the Microsoft Common Objects in Context (MS COCO) dataset, first released in 2014, was used for testing one embodiment of the system 400. In the example, a conservative erosion kernel of 12×12 pixels was set for mask erosion. With this erosion kernel size, it was reasonably ensured that the outline was not over-eroded even in the case of complex scene outlines and inaccurate masks. On the other hand, some variation freedom was lost through the relatively thick outline and the opportunity of applying the augmentation for very small objects was thereby also lost. Because the encoding and decoding of the latent space in SD is lossy, this lossiness may also cause alterations to parts of an image that should stay unchanged. In various embodiments, therefore, the original image may be kept in the unmodified part and the edges of the two parts blended with a Gaussian filter to circumvent this problem. In one experiment, SmartBrush was used evaluating the techniques using the Fréchet inception distance (FID). To make the results comparable, each image in the training set of COCO was resized to a size of 512 by 512. Then, two masks were sampled for each image, and eroded with a kernel of size 12. Notably, some masks occasionally vanished after erosion; in such cases, the masks were reverted back to using the original masks. The final results were resized to 256 by 256, as in SmartBrush. This yielded 9311 images that could be used for data augmentation through inpainting the eroded regions. Such example embodiment of techniques described herein thus resulted in an FID score of 4.38, as compared to a Blended Diffusion score of 8.16, a GLIDE score of 6.98, and SD Inpainting Score of 6.54, and SmartBrush score of 5.76. A “Local FID” score, comparing only the cutout of the bounding box around the object to focus more on the inpainted region was also calculated. To make the results comparable, the scores of the direct output from the inpainting method without the overlay of the original image on top of the unmasked part were reported. The resulting Local FID score of the techniques described herein result in 7.14, as compared to a Local FID score of 26.25 for Blended Diffusion, 24.25 for GLIDE, 15.16 for SD Inpainting, and 9.80 for SmartBrush. Finally, a CLIP score was calculated to measure text-image alignment. With the help of the provided COCO captions, the evaluation method was applied on the previously inpainted images. The techniques described herein thus outperform the current state of the art approaches, in the sense that the techniques herein generate samples that are perceptually closer to the original dataset. This was quantified both in terms of FID score over the whole image and as well as when computed only within the bounding box of the object. The techniques described herein achieve good results because they can replicate some important visual features, such as color and pattern, of the original image with relative case. For example, a big contribution to the increase in FID score stems from the fact that the unmasked area also went through alterations. The techniques also take advantage of using the actual outline of the object, a strong additional guidance, but more importantly a set of pixels that contains information about the visual feature of the original object. As an example, the model can fairly easily estimate the color of the inpainted object just by its outline.

The resulting CLIP score for the embodiment of the techniques described herein resulted in a clip score of 0.299 as compared to 0.244 for Blended Diffusion, 0.235 for GLIDE, 0.243 for SD Inpainting, and 0.249 for SmartBrush. The Clip score is an indication of how well the text prompt aligns with the image. As shown in the resulting CLIP scores, the techniques described herein achieve very good results, indicating the inpainted parts closely follow the content of the original image.

It is to be understood that the block diagram of FIG. 4 is not intended to indicate that the system 400 is to include all of the components shown in FIG. 4. Rather, the system 400 can include fewer or additional components not illustrated in FIG. 4 (e.g., additional datasets, generated additional annotated data samples, or additional trained segmentation machine learning models, etc.).

FIG. 5 is a set of images demonstrating an example generation 500 of training images based on a single image 502 of a bus. The segmented image 504 of the bus shows the original image 502 of the bus with a mask 504A that segments the bus from the background of the segmented image 504. In various examples, the mask 504A may also be annotated with a label “bus” that indicates the associated class of object being masked. In various embodiments, the mask 504A is reduced to result in the eroded mask 505B of image 506, along with a border 507 that has been removed from mask 504A. In the example of FIG. 5, the eroded mask 505B can then be used to erase an area of the bus while leavening an outer edge of the bus in the image. The eroded area contained within an inner border 507 of the edge of the bus is thus not erased.

The example generation 500 further includes an inpainting 508 that is executed to fill in the erased portion of mask 505B. For example, the inpainting 508 may be performed using any suitable diffusion-based inpainting model. In particular, the selected inpainting model may have been trained to fill out patches of an image, thereby endowing the inpainting model with the capacity to naturally extend objects.

The inpainting process 508 may be repeated to generate any number of different additional training images. In the example of FIG. 5, the inpainting 508 has been executed three times to generate additional training images 510A, 510B, and 510C. As shown in FIG. 5, each of the generate additional training images 510A, 510B, and 510C includes a different bus, having different doors, wheels, windows, storage units, etc. In various examples, the generated additional training images 510A, 510B, and 510C can be used with image 502 to train a segmentation machine learning model on various variations of buses. For example, image-mask pairs may be generated by combining the original annotated mask 504A with each of the generated additional training images 510A, 510B, and 510C. The image-mask pairs can then be included as synthetic variations of the annotated image 504 to augment the training dataset that the annotated image 504 was obtained from.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive an annotated data sample comprising an object contained in an annotated mask;
partially erase the object contained in the annotated mask; and
fill out an erased area of the object a predetermined number of times via a trained generative model to generate an additional annotated data sample.

2. The system of claim 1, wherein the trained generative model comprises a diffusion-based inpainting model.

3. The system of claim 1, wherein the generative model comprises an inpainting model trained on top of a latent diffusion model.

4. The system of claim 1, wherein the generated additional annotated data sample comprises an image-mask pair that comprises the annotated mask of the annotated data sample.

5. The system of claim 1, wherein the processor is to erode the annotated mask to generate an eroded mask and erase an area of the object within the eroded mask to partially erase the object.

6. The system of claim 1, wherein the processor is to blend an edge of the filled out area of the object with an original outer portion of the object that was not erased using a Gaussian filter.

7. The system of claim 1, wherein the processor is to input the associated class from the annotated mask as a text guidance into the diffusion-based inpainting model.

8. A computer-implemented method, comprising:
receiving, via a processor, an annotated data sample comprising an object contained in an annotated mask;
partially erasing, via the processor, the object contained in the annotated mask; and
filling out, via the processor, an erased area of the object via a trained generative model to generate an additional annotated data sample.

9. The computer-implemented method of claim 8, further comprising training a segmentation learning model using the generated additional annotated data sample.

10. The computer-implemented method of claim 8, wherein the generated additional annotated data sample comprises the annotated mask from the annotated data sample.

11. The computer-implemented method of claim 8, further comprising receiving a text prompt and filling out the erased area using a diffusion-based inpainting model guided by the text prompt.

12. The computer-implemented method of claim 8, wherein partially erasing the object comprises eroding the annotated mask to generate an eroded mask and erasing an area of the object within the eroded mask.

13. The computer-implemented method of claim 8, wherein filling out the erased area comprises blending an edge of the filled out area of the object with an original outer portion of the object that was not erased using a Gaussian filter.

14. The computer-implemented method of claim 8, further comprising filling out, via the processor, the erased area of the object via the generative model a predetermined number of times to generate a plurality of additional annotated data samples having the same annotation as the annotated data sample.

15. A computer program product for generation of annotated data samples, the computer program product comprising a computer-readable storage medium having program code embodied therewith, the program code executable by a processor to cause the processor to:
receive an annotated data sample comprising an object contained in an annotated mask;
partially erase the object contained in the annotated mask; and
fill out an erased area of the object a predetermined number of times via a generative model to generate additional annotated data samples.

16. The computer program product of claim 15, further comprising program code executable by the processor to train a segmentation learning model using the generated additional annotated data samples.

17. The computer program product of claim 15, further comprising program code executable by the processor to receive a text prompt and fill out the erased area using a diffusion-based inpainting model guided by the text prompt.

18. The computer program product of claim 15, further comprising program code executable by the processor to erode the annotated mask to generate an eroded mask and erase an area of the object within the eroded mask.

19. The computer program product of claim 15, further comprising program code executable by the processor to receive an erosion kernel and erode the annotated mask based on the erosion kernel.

20. The computer program product of claim 15, further comprising program code executable by the processor to fill the erased area of the object via the generative model a predetermined number of times to generate a plurality of additional annotated data samples having the same annotation as the annotated data sample.
